(19) United States
(12) Patent Application Publication
(10) Pub. No.: US 2025/0081985 A1
(43) Pub. Date: Mar. 13, 2025

(54) A NATURAL, PLANT BASE CONFECTIONARY AND METHOD FOR THE PRODUCTION THEREOF

(71) Applicant: YOFFI MUTZARIM AGSACH LTD., Kibbutz Shluhot (IL)

(72) Inventors: Liran GRUDA, Haifa (IL); Asaf COHEN, Nahariya (IL)

(21) Appl. No.: 18/580,311

(22) PCT Filed: Jul. 25, 2022
(86) PCT No.: PCT/IL2022/050800

§ 371 Date: Jan. 18, 2024

Related U.S. Application Data
(60) Provisional application No. 63/225,641, filed on Jul. 26, 2021.

(51) Int. Cl. A23G 3/42; A23G 3/34; A23G 3/48; A23G 3/52; A23L 19/00; A23P 30/40

(52) U.S. Cl. CPC A23G 3/42; A23G 3/0044; A23G 3/0046; A23G 3/48; A23G 3/52; A23L 19/09; A23P 30/40

(57) ABSTRACT

The present invention discloses an aerated confectionary, comprising: a liquid phase; and a dispersed gaseous phase; wherein said liquid phase comprises: a saccharide-rich plant product; and at least one stabilizer. The invention also discloses a method for the production of plant-based aerated confectionary characterized by density of about O 0.25 to about O 0.8 g/ml, the method comprising steps of obtaining at least one saccharide-rich plant product; separating the liquid component of said extract; enriching the saccharide content of said liquid; obtaining at least one stabilizing agent; mixing said enriched liquid and said stabilizing agent(s) to obtain a homogeneous mass; heating said mass; aerating said mass; and cooling said aerated mass.

### FIELD OF THE INVENTION

The invention generally pertains to the field of confectionaries, and more specifically to a natural, plant base marshmallow. The invention also relates to methods for the production of the same.

### BACKGROUND OF THE INVENTION

Confectionaries, and especially aerated confections such as marshmallows are an unusual type of sweet treat: spongy, sticky and a little bit chewy. They have a melting point that is just above body temperature so that they start to change from a solid to a liquid state as soon as they reach the warmth of your mouth, or even better in nature using open fire. They're also an ancient creation, originally coming from a tall marshmallow plant (Althaea officinalis) that grows in swampy fields and has a soft, spongy root. Its root contains mucilage, a thick, gluey substance produced by some plants and microscopic animals to help with food storage and seed germination. Some cultures used the plant to make candy, whereas others used it to make medicine. The ancient Egyptians, for example, dried the root and mixed it with honey to make marshmallow treats, but the French experimented with using its gummy juice to soothe sore throats. Modern marshmallows no longer contain parts of the marshmallow plant. Instead, the store-bought version is primarily a mix of three ingredients: sugar, corn syrup and gelatin. The gelatin replaces the thick, gluey substance from the marshmallow plant. Varying the ratio of sugar to corn syrup can significantly affect what the resultant marshmallows are like.

Sugar confections often refer to sugar-based foods, usually eaten as a snack or a dessert. Often included are sugar candies, candied fruits and nuts and chewing gum.

The molecular structure of marshmallows can be described as a sugar solution blended with stabilizing structure agents, such as gelatin, xanthan gum, or egg whites and air. Marshmallows are typically produced as a final density of about 0.5 g/ml. The aforementioned structural components prevent the air from escaping and collapsing the marshmallows during and following aeration.

There exists a long-felt need for confectionaries made with natural ingredients.

### SUMMARY OF THE INVENTION

It is thus an object of the invention to disclose a method for the production of plant-based aerated confectionary characterized by density of about 0.25 to about 0.8 g/ml, the method characterized by steps of obtaining clear fruit or vegetable concentrate of about 80 to about 90%; fat, about 0.0075 to about 0.5%; gelatin about 4 to about 7.5%, colorant about 1% to about 2.5%; carrot juice about 6 to about 9%; and flavour agent about 0.7 to about 2.5%; cooking the same in an open pot at about 97 to about 110° C.; admixing fat at temperature of about 110 to about 125° C. until a concentration of about 80 to about 90° Bx is yielded; transferring the hereto cooked concentrate to an intermediate container with a stirrer and cool to a temperature of about 80° C.; admixing gelatin solution, color agents and extract; possibly, transferring to a work container; whipping the same in a continuous frother while introducing air and reaching a specific gravity of about 180 to about 220g per liter; transferring the same to an extruder and pouring the marshmallow; and if required, admixing on or more of the following: oil, fat, antifoam agents including silicone materials to reduce the amount of bubbles during the boiling process.

It is another object of the invention to disclose a method for the production of plant-based aerated confectionary characterized by density of about 0.25 to about 0.8 g/ml, the method comprising steps of obtaining at least one saccharide-rich plant product; separating the liquid component of said extract; enriching the saccharide content of said liquid; obtain at least one stabilizing agent; mixing said enriched liquid and said stabilizing agent(s) to obtain a homogeneous mass; heating said mass; aerating said mass; and cooling said aerated mass. It is in the scope of eth invention wherein one or more food additives are admixed in one or more of the production steps.

It is another object of the invention to disclose the method as defined in any of the above, wherein the aerated confectionary is a marshmallow is a marshmallow and/or the plant is carrot is one or more members of a group consisting of carrot and, pear and apple or otherwise comprises one or more of the same.

It is another object of the invention to disclose the method as defined in any of the above, wherein the plant product is characterized as one or more of the followings: a juice, a concentrate, and extract.

It is another object of the invention to disclose the method as defined in any of the above, wherein the plant product extract is obtained from homogeneous of heterogenous vegetable raw-material selected from tubulars, vegetables, barriers and fruits.

It is another object of the invention to disclose the method as defined in any of the above, wherein the separating of said liquid extract from solid extract is conducted by a technology selected from extracting, distillating, filtrating, applying sedimentation and decanting,

It is another object of the invention to disclose the method as defined in any of the above, wherein the saccharide is selected from a group consisting of glucose, sucrose, fructose, dextrin, maltose, and dextrose.

It is another object of the invention to disclose the method as defined in any of the above, wherein the step of enriching said liquid is conducted to reach brix in the range of about 40 to about 90° Bx.

It is another object of the invention to disclose the method as defined in any of the above, wherein the plant product has a Brix measurement of about 60 to about 80° Bx.

It is another object of the invention to disclose the method as defined in any of the above, wherein the stabilizing agent is selected from a group consisting of emulsifiers, thickeners and gelling agents, foam stabilizers, humectants, anticaking agents, and coating agents, alginate, agar, carrageen, cellulose, CMC and cellulose derivatives, gelatin, guar gum, gum Arabic, locust bean gum, pectin, starch, xanthan gum, proteins, albumen, gellan gum, LBG and a mixture thereof.

It is another object of the invention to disclose the method as defined in any of the above, wherein the method additionally comprising a step of adding sugar.

It is another object of the invention to disclose the method as defined in any of the above, wherein the method additionally comprising a step of whetting or dissolving said stabilizer.

It is another object of the invention to disclose the method as defined in any of the above, wherein the method additionally comprising a step of adding a dietary fiber, said fibers selected from a group consisting of polysaccharides, oligosaccharides, fructo-oligosaccharides, oligofructose, oligo-fructofuranans, inulin, Isomalto-oligosaccharide, isomalto-oligosaccharide and any combination thereof.

It is another object of the invention to disclose the method as defined in any of the above, wherein the step of aerating said mass is conducted by a technology selected from wiping, mixing, spraying and passing through a nozzle.

It is another object of the invention to disclose the method as defined in any of the above, wherein the method additionally comprising steps selected from a group consisting of cooling, extruding, shaping, molding, 2D or 3D printing and cutting.

It is another object of the invention to disclose an aerated confectionary characterized by a density of about 0.25 to about 0.8 g/ml, comprising a saccharide-rich plant product; a stabilizer; and an aeratable gas.

It is another object of the invention to disclose a low calory aerated confectionary characterized by a density of about 0.25 to about 0.8 g/ml, essentially having the following three a saccharide-rich plant product; a stabilizer; and an aeratable gas.

It is another object of the invention to disclose a low-calorie aerated confectionary characterized by a density of about 0.25 to about 0.8 g/ml, said aerated confectionary consists a saccharide-rich plant product; a stabilizer; an aeratable gas; and possibly also one or more food additives.

It is another object of the invention to disclose the aerated confectionary as defined in any of the above, wherein the aerated confectionary is a marshmallow.

It is another object of the invention to disclose the aerated confectionary as defined in any of the above, wherein the plant product is characterized as one or more of the followings: a juice, a concentrate, and extract.

It is another object of the invention to disclose the aerated confectionary as defined in any of the above, wherein the plant product extract is obtained from homogeneous of heterogenous vegetable raw-material selected from tubulars, vegetables, barriers and fruits.

It is another object of the invention to disclose the aerated confectionary as defined in any of the above, wherein the plant product has a Bix measurement of about 50 to about 90° Bx.

It is another object of the invention to disclose the aerated confectionary as defined in any of the above, wherein the plant product has a Bix measurement of about 70 to about 90° Bx.

It is another object of the invention to disclose the aerated confectionary as defined in any of the above, wherein the plant product is characterized as a juice, a concentrate, an extract or a mixture thereof.

It is another object of the invention to disclose the aerated confectionary as defined in any of the above, wherein the product comprises at least about 40% of said confectionary.

It is another object of the invention to disclose the aerated confectionary as defined in any of the above, wherein the plant product comprises at least about 70% of said confectionary.

It is another object of the invention to disclose the aerated confectionary as defined in any of the above, wherein the plant product comprises about 80 to about 90% of said confectionary.

It is another object of the invention to disclose the aerated confectionary as defined in any of the above, additionally comprising sugar, comprising about 1 to about 30% of said confectionary.

It is another object of the invention to disclose the aerated confectionary as defined in any of the above, wherein the saccharide is selected from a group consisting of monosaccharides, disaccharides, polysaccharides and a mixture thereof.

It is another object of the invention to disclose the aerated confectionary as defined in any of the above, wherein the saccharide is selected from a group consisting of glucose, sucrose, fructose, dextrin, maltose, dextrose and a mixture thereof.

It is another object of the invention to disclose the aerated confectionary as defined in any of the above, wherein the stabilizing agent is selected from a group consisting of emulsifiers, thickeners and gelling agents, foam stabilizers, humectants, anticaking agents, and coating agents, alginate, agar, carrageen, cellulose, CMC and cellulose derivatives, gelatin, guar gum, gum Arabic, locust bean gum, pectin, starch, xanthan gum, proteins, albumen, gellan gum, LBG and a mixture thereof.

It is another object of the invention to disclose the aerated confectionary as defined in any of the above, wherein the stabilizer comprises about 1 to about 4.5% of said confectionary.

It is another object of the invention to disclose the aerated confectionary as defined in any of the above, wherein the confectionary is characterized as crystal free.

It is another object of the invention to disclose the aerated confectionary as defined in any of the above, wherein the saccharide content comprises less than about 20% invert sugar or alternatively, less than about 10% invert sugar.

It is another object of the invention to disclose the aerated confectionary as defined in any of the above, wherein the it additionally comprising fibers, said fibers selected from a group consisting of polysaccharides, oligosaccharides, fructo-oligosaccharides, oligofructose, oligo-fructofuranans, inulin, isomalto-oligosaccharide, isomalto-oligosaccharide and any combination thereof.

It is another object of the invention to disclose the aerated confectionary as defined in any of the above, wherein the fibers comprising about 1 to about 4.5/15% of said confectionary.

It is another object of the invention to disclose the aerated confectionary comprising a liquid phase; and a dispersed gaseous phase; wherein said liquid phase comprises: a saccharide-rich plant product; and at least one stabilizer.

It is another object of the invention to disclose the aerated confectionary as defined in any of the above, wherein the aerated confectionary is a marshmallow.

It is another object of the invention to disclose the aerated confectionary as defined in any of the above, wherein the plant product is characterized as one or more of the followings: a juice, a concentrate, and extract.

It is another object of the invention to disclose the aerated confectionary as defined in any of the above, wherein the plant product extract is obtained from homogeneous of heterogenous vegetable raw-material selected from tubulars, vegetables, barriers and fruits.

It is another object of the invention to disclose the aerated confectionary as defined in any of the above, wherein the plant product has a Bix measurement of about 40 to about 90° Bx.

It is another object of the invention to disclose the aerated confectionary as defined in any of the above, wherein the plant product has a Bix measurement of about 60 to about 80° Bx.

It is another object of the invention to disclose the aerated confectionary as defined in any of the above, wherein the plant product is characterized as a juice, a concentrate, an extract or a mixture thereof.

It is another object of the invention to disclose the aerated confectionary as defined in any of the above, wherein the plant product comprises at least about 40% of said confectionary.

It is another object of the invention to disclose the aerated confectionary as defined in any of the above, wherein the said plant product comprises at least about 70% of said confectionary.

It is another object of the invention to disclose the aerated confectionary as defined in any of the above, wherein the plant product comprises about 82% of said confectionary.

It is another object of the invention to disclose the aerated confectionary as defined in any of the above, additionally comprising sugar, said sugar comprising less than about 30% of said confectionary.

It is another object of the invention to disclose the aerated confectionary as defined in any of the above, wherein the saccharide is selected from a group consisting of monosaccharides, disaccharides, polysaccharides and a mixture thereof.

It is another object of the invention to disclose the aerated confectionary as defined in any of the above, wherein the saccharide is selected from a group consisting of glucose, sucrose, fructose, dextrin, maltose, dextrose and a mixture thereof.

It is another object of the invention to disclose the aerated confectionary as defined in any of the above, wherein the stabilizing agent is selected from a group consisting of emulsifiers, thickeners and gelling agents, foam stabilizers, humectants, anticaking agents, and coating agents, alginate, agar, carrageen, cellulose, CMC and cellulose derivatives, gelatin, guar gum, gum Arabic, locust bean gum, pectin, starch, xanthan gum, proteins, albumen, gellan gum, LBG and a mixture thereof.

It is another object of the invention to disclose the aerated confectionary as defined in any of the above, wherein the stabilizer comprises about 1 to about 15/4.5% of said confectionary.

It is another object of the invention to disclose the aerated confectionary as defined in any of the above, wherein the saccharide content comprises about 1 to about 20% or alternatively, about 1 to about 10/20% invert sugar.

It is another object of the invention to disclose the aerated confectionary as defined in any of the above, additionally comprising fibers, said fibers selected from a group consisting of polysaccharides, oligosaccharides, fructo-oligosaccharides, oligofructose, oligo-fructofuranans, inulin, Isomalto-oligosaccharide, isomalto-oligosaccharide and any combination thereof.

It is another object of the invention to disclose the aerated confectionary as defined in any of the above, wherein the fibers comprising about 1 to about 15% of said confectionary.

It is another object of the invention to disclose an aerated confectionary wherein (i) at least one or (ii) two or (iii) three or (iv) more than three of the following is being held true: the confiture is having a density of about 0.25 to about 0.8 g/ml; is being crystal free; is having a moisture content comprising about 12 to about 20/25% W/W of the composition; is comprising only natural ingredients; is having said gaseous phase stabilized in said liquid phase; is being vegan; and is being vegetarian and/or Kosher.

It is another object of the invention to disclose the aerated confectionary as defined in any of the above, wherein the confectionary is characterized as comprising no additional sugars.

### BRIEF DESCRIPTION OF THE PREFERRED EMBODIMENTS

The accompanying drawings, which are included to provide a further understanding of the invention and are incorporated in and constitute a part of this specification, illustrate embodiments of the invention and together with the description serve to explain the principles of the invention wherein:

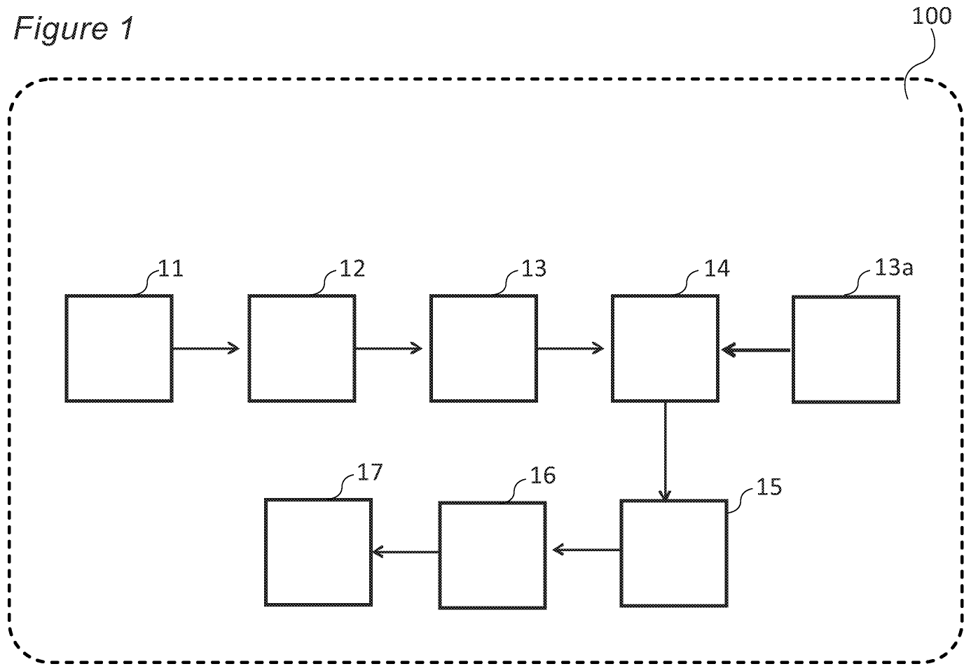

FIG. 1 presents a schematic representation of the system according to one embodiment of the present invention;

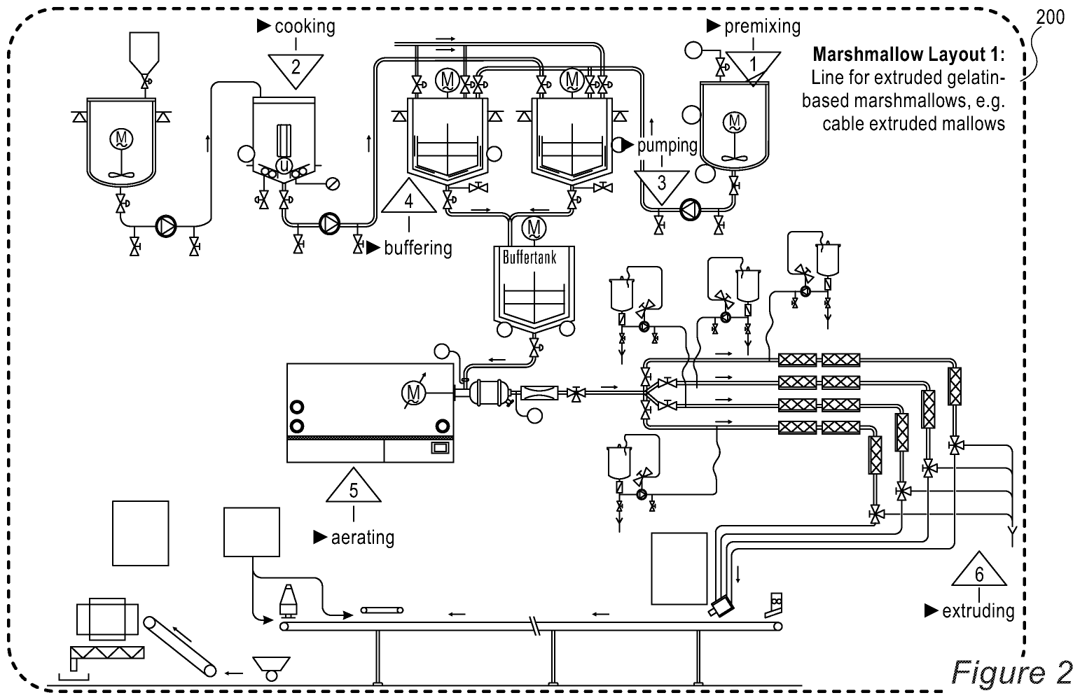

FIG. 2 presents a sample system the present invention, according to another embodiment of the present invention, as provided in the first example;

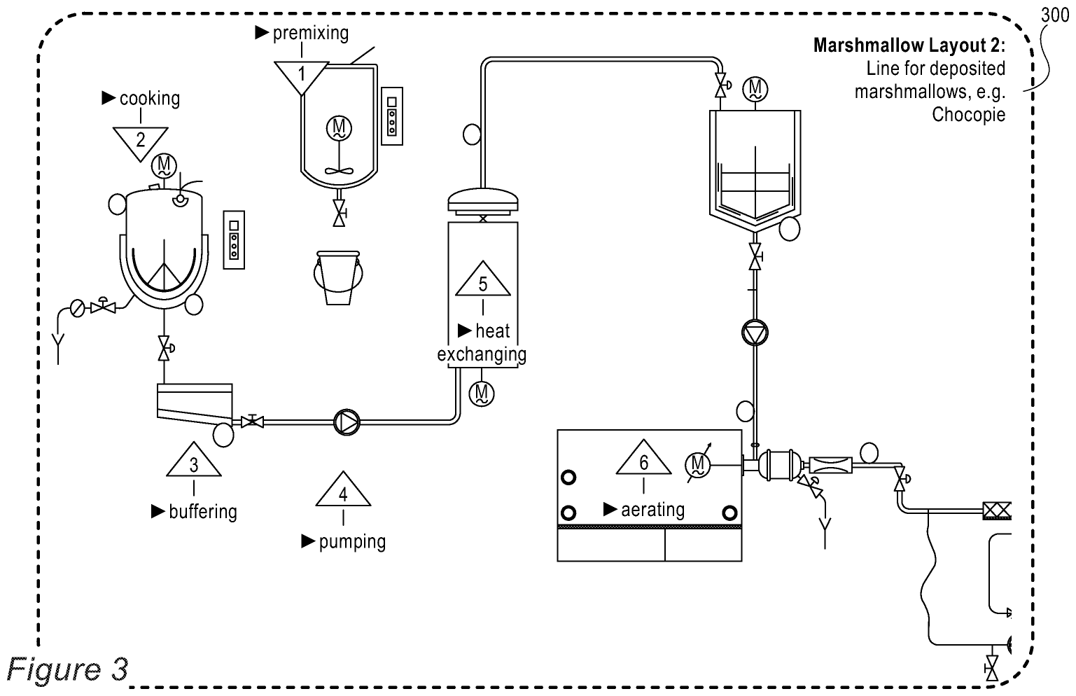

FIG. 3 presents a sample system the present invention, according to another embodiment of the present invention, as provided in the second example; and

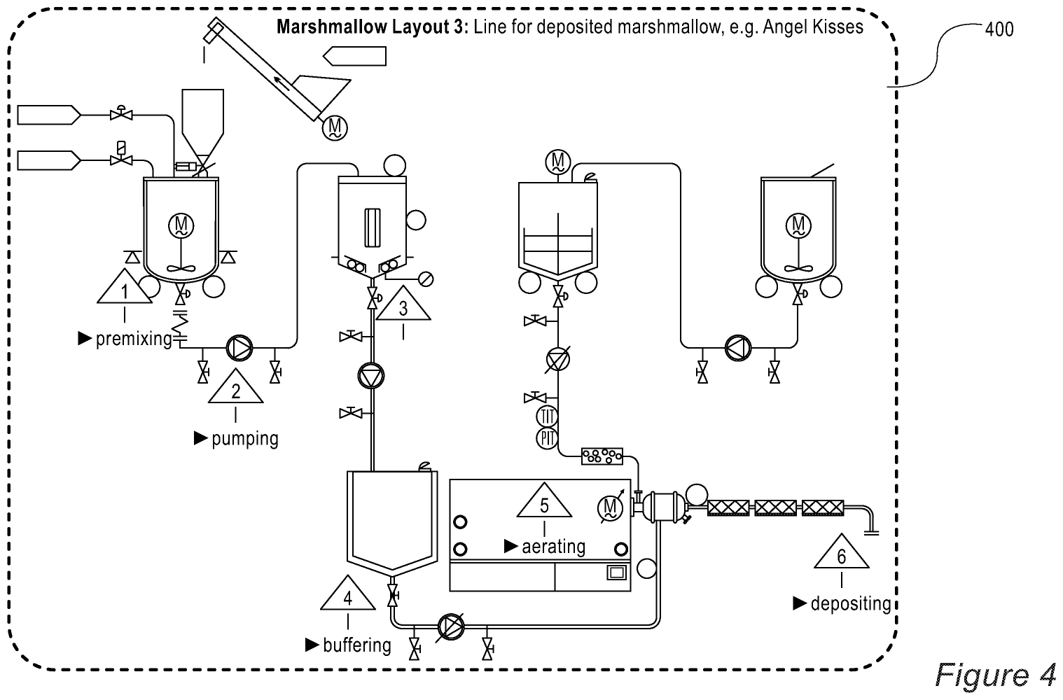

FIG. 4 presents a sample system the present invention, according to another embodiment of the present invention, as provided in the third example.

### DETAILED DESCRIPTION OF THE PREFERRED EMBODIMENTS

The following description is provided, alongside all chapters of the present invention, so as to enable any person skilled in the art to make use of the invention and sets forth the best modes contemplated by the inventor of carrying out this invention. Various modifications, however, are adapted to remain apparent to those skilled in the art, since the generic principles of the present invention have been defined specifically to provide compositions and methods.

In this application the terms “marshmallow” and “aerated confections” interchangeably refer herein after to confitures comprising about 40% to about 75% air. Unless otherwise stated, all concentrations expressed as % W/W (weight by weight).

Unless otherwise stated, with reference to numerical quantities, the term “about” refers to a tolerance of ±25% of the stated nominal values. Unless otherwise stated, all numerical ranges are inclusive of the stated limits of the range.

The marshmallow is characterized as a foam or an emulsion, consisting of an continuous aqueous phase and a dispersed gaseous phase, i.e. a liquid with gas bubbles stabilized throughout. This also makes marshmallows an “aerated confection” because it is made up of a significant part of air, e.g., about 40% to about 75% air. The goal of an aerated confection like marshmallow is to incorporate gas (air) into a sugar mixture, and stabilize the aerated product before the fluid, e.g., gas, air etc. can escape. When the gas is introduced into the system, tiny air bubbles are trapped, contributing to the unique textural properties, in effect to the mouth-feel of the product.

The term “food additives” refers in a non-limiting manner to substances added to food to preserve flavor or enhance its taste, appearance, or other qualities and selected in a non-limiting from the following Acidulants confer sour or acid taste, such as vinegar, citric acid, tartaric acid, malic acid, fumaric acid, and lactic acid; Acidity regulators; Acidity regulators; Anticaking agents; Anticaking agents; Antifoaming and foaming agents; Antifoaming agents; Antioxidants; Bulking agents; Food coloring; Fortifying agents such as vitamins, minerals, and dietary supplements to increase the nutritional value; Color retention agents; Emulsifiers; Flavors; Flavor enhancers; Flour treatment agents; Glazing agents; Humectants; Tracer gas; Preservatives; Stabilizers; Sweeteners; Thickeners; and Packaging agents.

Sweeteners are added to foods for flavoring. Sweeteners other than sugar are added to keep the food energy (calories) low, or because they have beneficial effects regarding diabetes mellitus, tooth decay, or diarrhea.

Commercially available marshmallows typically consist of four ingredients: sugar, water, air, and a whipping agent (or stabilizing agents) such as gelatin, xanthan gum, or protein, such as lecithin or egg whites. The type of sugar and stabilizing agents affect the nature of the product and therefore vary depending on desired characteristics.

As for the sugars, marshmallows are considered to be an amorphous solid because of how the sugars crystallize. This is because the crystals formed are not grained, and very fine in size, as opposed to its crystalline counterpart where the crystals are grainy, and larger in size. Temperature is an important parameter in the production of marshmallows. To make an amorphous solid like marshmallow, the sugar syrup solution, typically comprising sucrose, corn syrup, and invert sugar, is heated at a high temperature. It is then cooled so rapidly that no crystals are formed, so that glass (amorphous-) crystals are created instead. In most confections, a combination of different sugars is used, each of which influence the solubility and concentration of one another. The presence of invert sugar and/or corn syrup substantially decreases the solubility of sucrose, due to the competition among the sugar molecules for water.

In general terms and in the field of cooking, “syrup” is a condiment that is a thick, viscous liquid consisting primarily of a solution of sugar in water, containing a large amount of dissolved sugars but showing little tendency to deposit crystals. Again, defined here in a non-limiting manner, commercially utilized syrups are e.g., glucose syrup, corn syrup, maple syrup, high fructose corn syrup, golden syrup, a by-product of refining crystallized sugar, cane syrup, made from sugar canes and agave syrup, made from agave stem.

A traditional marshmallow might contain about 60% corn syrup and 30% sugar. The corn syrup/sugar ratio will provide only about 35% to 40% solids to prevent crystallization. Crystallization can be further avoided with proper selection of the corn syrup type. A higher conversion corn syrup will contribute more invert sugar to the formula, which inhibits crystallization. If a grainier-more textured marshmallow is desired, the sugar ratio is increased to the point where about 60% to 65% is crystallized, then whip it, with a small amount of powdered sugar is added. As the mixture cools, the sugar crystallizes out to form the grained marshmallow.

Herein below are described a few members of the sugar family, commonly utilized in the production of aerated confitures: Sucrose is the ingredient utilized in most aerated confections. It is a disaccharide that consists of one glucose and fructose molecule. This sugar provides sweetness and bulk to the marshmallow, while simultaneously setting the foam to a firm consistency as it cools. Sucrose, and sugars in general, impair the ability of a foam to form, but improve foam stability. Therefore, sucrose is used in conjunction with a protein like gelatin. The protein can adsorb, unfold, and form a stable network, while the sugar can increase the viscosity. Liquid drainage of the continuous phase must be minimized as well. Thick liquids drain more slowly than thin ones, and so increasing the viscosity of the continuous phase will reduce drainage. A high viscosity is essential if a stable foam is to be produced. Therefore, sucrose is a main component of marshmallow. But sucrose is seldom used on its own, because of its tendency to crystallize. Corn syrup, sometimes known as glucose syrup, typically contains dextrin, maltose, and dextrose. Partial hydrolysis of cornstarch obtains it. Corn syrup is important in the production of marshmallow because it prevents the crystallization of other sugars like sucrose. It may also contribute body, reduce sweetness, and alter flavor release, depending on the Dextrose Equivalent (DE value) of the glucose syrup used. The DE is the measure of the amount of reducing sugars present in a sugar product in relation to glucose. Lower-DE glucose syrups will provide a chewier texture, while higher-DE syrups will make the product tenderer. In addition, depending on the type of DE used, can alter the sweetness, hygroscopicity, and browning of the marshmallow. Corn syrup is flavorless and cheap to produce which is why candy companies love using this product. Likewise, invert sugar is produced when sucrose breaks down due to the addition of water, also known as hydrolysis. This molecule exhibits all the characteristics of honey except the flavor because it is the primary sugar found in honey. This means that invert sugar has the ability to prevent crystallization, and produce a tender marshmallow. It is also an effective humectant, which allows it to trap water, and prevent the marshmallow from drying out. For some candies, this is not a good trait to have, but for marshmallows, it is an advantage since it has high moisture content.

Stabilizing agents are also key ingredients in the production of aerated confitures. In traditional marshmallow, gelatin is the main stabilizing agent and constituents 1 to 2% of the mixture. Proteins are the main surface-active agents responsible for the formation, and stabilization of the dispersed air. Due to their structure, surface-active molecules gather at the surface area of a portion of (water-based) liquid. A portion of each protein molecule is hydrophilic, with a polar charge, and another portion is hydrophobic and non-polar. The non-polar section has little or no affinity for water, and so this section orients as far away from the water as possible. However, the polar section is attracted to the water and has little or no affinity for the air. Therefore, the molecule orients with the polar section in the water, with the non-polar section in the air. Two primary proteins that are commonly used as aerators in marshmallows are gelatin and albumen (egg whites). Gelatin is the aerator most often used in the production of marshmallows. It is made up of collagen, a structural protein derived from animal skin, connective tissue, and bones. Not only can it stabilize foams, like albumen, but when combined with water it forms a thermally-reversible gel. This means that gelatin can melt, then reset due to its sensitivity to temperature. The melting point of gelatin gel is around 35° C., which is just below normal body temperature of about 36° C. This is what contributes to the “melt-in-your-mouth” sensation when a marshmallow is consumed, it actually starts to melt when it touches the tongue. During preparation, the temperature needs to be just above the melting point of the gelatin, so that as soon as it is formed it cools quickly, and the gelatin will set, retaining the desired shape. If the marshmallow rope mixture exiting the extruder during processing is too warm, the marshmallow starts to flow before the gelatin sets. Instead of a round marshmallow, it will take a more oval form. Excessive heat can also degrade, or break down, the gelatin itself. Therefore, when marshmallows are being produced at home or by artisan candy makers, the gelatin is added after the syrup has been heated and cooled down. Albumen is a mixture of proteins found in egg whites, and is utilized for its capacity to create foams. In a commercialized setting, dried albumen is used as opposed to fresh egg whites. In addition to convenience, the advantages of using dried albumen are an increase in food safety, and the reduction of water content in the marshmallow. Fresh egg whites carry a higher risk of Salmonella, and are approximately % water. This is undesirable for the shelf life and firmness of the product. For artisan-type marshmallows, prepared by a candy maker, fresh egg whites are usually used. Albumen is rarely used on its own when incorporated into modern marshmallows, and instead is used in conjunction with gelatin. In commercial operations, the gelatin is cooked directly with sugar syrup. The kinetics of the process play are important role, with both time and temperature factoring in. If the gelatin was added at the beginning of a batch that was then cooked to about 112 to 116° C. in about 20 to 30 minutes, a significant amount of gelatin would break down. The marshmallow would have reduced springiness from that loss of gelatin. But since the time the syrup spends at elevated temperature in modern cookers is so short, there is little to no degradation of the gelatin. In terms of texture, and mouth-feel, gelatin makes the finished marshmallows chewy by contributing to the forming of a 3D network of polymer chains. The gelatin dissolved in warm water, forming a dispersion, resulting in the cross-linking of its helix-shaped chains. This linkage traps the air in the marshmallow mixture and immobilize the water molecules. This results in the well-known spongy structure of marshmallows. The omission of gelatin from a marshmallow recipe results in marshmallow crème, as there is no gelatin network to trap and immobilize the water and air bubbles.

In industry the marshmallow preparation starts with the cooking of gelatin with sugar and syrup. After the gelatin-containing syrup is cooked, it is allowed to cool slightly before incorporating air. Aerating can be accomplished by wiping, generally accomplished by a rotor-stator type device. Compressed air is injected into the warm syrup, held at a temperature just above the melting point of gelatin. In a marshmallow aerator, pins on a rotating cylinder (rotor) intermesh with stationary pins on the wall (stator) provide the shear forces necessary to break the large injected air bubbles into numerous tiny bubbles that provide the smooth, fine-grained texture of the marshmallow. A continuous stream of light, fluffy marshmallow exits the aerator enroute to the forming step.

It is one object of the present invention to provides a useful means for the production of marshmallows which comprising saccharide-rich fruit and/or vegetable product comprising at least about 40%, or alternatively at least 50%, or alternatively at least 60%, or alternatively at least about 70% of the marshmallow content. In some embodiments the marshmallow comprises at least about 90% fruit and/or vegetable product. The fruit or vegetable products could be characterized as an extract, juice and concentrates and having a brix of at least or alternatively at least 30%, or alternatively at least about 40%, or alternatively at least about 50%. In some embodiments the product has a brix of about 70 to about 90 Brix.

The fruit and vegetable products can be sourced from various saccharide-rich fruits, selected in a non-limiting manner from berries, e.g., genus Vitis, such as grapes; family Rutaceae, e.g., genus citrus, such as citrus; clade Eudicots, e.g., family Ericaceae, genus Vaccinium, e.g., blueberries; members of the order Rosales and family Rosacea, e.g., genus Malus, such as apples, or same family, tribe Cucurbiteae, genus Cucurbita, e.g., pumpkin, or in the same family, order Brassicales, e.g., genus Brassica, such as turnip; subtribe Malinae, genus Pyrus such as pears or otherwise order Fabales, Familiy Fabavrae, e.g., genus Pisum, such as peas; and vegetables such clade Asterids, e.g., order Apiales, family Apiaceae, genus Daucus, such as carrots or other member of the Asteids, order Solanales, e.g., genus Solanum, such as tomato or potato; members of the order Caryophyllales, family Amaranthaceae, e.g., genus Beta, such as beats etc.

For stabilizing agent. In some embodiments of the invention the stabilizer is selected from Gelatin and Gelatin alternatives comprising e.g., stabilizers, such as LBG, cellulose, pectin, starches, agar, carrageenan, jelly etc., and a whipping compound. such as protein, including protein isolates, protein concentrates and protein hydrolysates. e.g., in the range of about 30% to about 90%.

Optional additions according to yet another set of embodiments are dietary fibers, such as polysaccharides or oligo-saccharides from fructans: fructo-oligosaccharides (FOS), oligofructose, oligo-fructans, inulin, glucose: Isomalto-oligosaccharide (IMO), isomalto-oligosaccharide etc. Pigments or coloring agents can be also added. In some embodiments, the pigments are generated by the carrots or are from additional natural sources.

It is well in the scope of the invention wherein the hereto disclosed marshmallows are characterized by being a low-calorie dish. Table 1 shows the caloric value of various currently commercially available products, where the hereto disclosed carrot-based marshmallow has about 6 to about 22% less calorie value than others:

TABLE 1
Calorie value of various commercially available marshmallows
are significantly higher than the hereto disclosed product.

| marshmallow | Kcal (100 g) |
|---|---|
| Dandies marshmallow | 358 |
| Currently commercially available | 320 |
| marshmallow | |
| Artisanal marshmallow | 300 |
| The hereto disclosed marshmallow | 280 |

A few methods are hereto presented for the production of plant-based aerated confectionary. In general terms, the methods comprise steps of obtaining at least one saccharide-rich plant product; separating the liquid component of said extract; enriching the saccharide content of said liquid; obtaining at least one stabilizing agent; mixing said enriched liquid and said stabilizing agent(s) to obtain a homogeneous mass; heating the mass; aerating the mass; cooling the aerated mass so that the aerated confectionary is characterized by a density ranging from about 0.25 to about 0.8 gram to milliliter.

### First Process

In this embodiment of the invention, a processing of whole carrot, pear and/or apple or any mixture thereof is provided useful for to produce carrot-pulp and carrot-liquid (defined as “juice” and/or “extract”). The process comprises steps as follows: Concentrating the liquid/juice/extract: heating and extracting the water to reach a range of about 50 to about 80 or to about 90° Bx. It is in the scope of the invention wherein at least one of the following is held true: liquid(s) is/are utilized, pulp(s) is/are utilized, and a mixture of liquid(s) and pulp(s) are utilized. Heating the enriched liquid to reach the melting point/temperature of the sugars. Creating a solution for wetting the stabilizing agents and proteins in water and rehydrating the stabilizing agents and/or proteins under effective stirring and heat conditions. Combining the concentrated carrot, pear and/or apple extract and stabilizer solution to create a homogeneous mass. Aerating in two or more steps: Introducing fluids, such as gases (e.g., air) into the mass: Wiping the mass by mechanical means; and then passing the mass through a nozzle e.g., (extruder dies); Transferring the mass; Drying and/or covering the mass in a powder. e.g., powder comprising one or more of the following: carrot, pear and/or apple powder, corn flour, starches, dextrose, sugar powders etc.; Cutting or otherwise shaping the mass; providing either a continuous, e.g., by means of an extruder, or a batch-wise cooling e.g., in molds and then Packaging the yielded product.

### Second Process

In this embodiment of the invention, a processing one or more members of a group consisting of carrot and, pear and apple to produce carrot, pear or apple pulp and carrot, pear or apple liquid, defined as juice and/or extract, is provided by steps as follows: Separating of the liquids from solids; Concentrating one or more of et followings: liquid, juice and extract: heating and extracting the water to reach a range of at least 40° Bx or alternatively at least 67° Bx or alternatively at least 75° Bx, or alternatively 90° Bx. It is an optional step to admix sweetened fibers or solids. Next step is heating the enriched liquid to reach the melting point of the sugars or other relevant temperature thereof; Combining the concentrated liquid and stabilizers to create a homogeneous mass; Heating mass to reach the activation heat of the stabilizers; Aerating: Introducing gases (e.g., air) into the candy mass by Wiping the mass by mechanical means and if extruder is utilized, Passing the mass through a nozzle as defined above. Then, other steps are provided useful: Transferring the mass; Drying and/or covering the mass in a powder, e.g., carrot, apple or pear powder, corn flour, etc., Cutting or otherwise shaping the mass; Cooling in either continuous or batch-wise unit operation and then Packaging.

### Third Process

In this embodiment of the invention, a processing of one or more members of a group consisting of carrot and, pear and apple to produce carrot, pear or apple pulp and carrot pear or apple liquid, defined here as juice and/or an extract. Steps are as follows: Separating liquid from solids; concentrating the liquid, juice, and/or extract: heating and extracting water to reach a range of about 40/80 to about 90° Bx; Heating the concentrate to reach the melting point as defined above; Combining the concentrated carrot extract and stabilizers to create a homogeneous mass; Heating mass to reach the activation heat of the stabilizers; Aerating e.g., by introducing gases (air, nitrogen etc.) into the mass; Wiping the mass by mechanical means and if extruder is utilized, Passing the mass through a nozzle as defined above. Then, a series of steps is followed: Transferring the mass; Drying and powdering the mass, e.g., by means of carrot, pear or apple powder, corn, pear or apple flour, etc.; Cutting and/or shaping the mass; Cooling as defined above and then Packaging.

### Fourth Process

In this embodiment of the invention, Processing s one or more members of a group consisting of carrot, pear and apple to produce carrot, pear or apple pulp and/or carrot, pear or apple liquid (defined as juice and/or extract) is provided useful by the following steps: Separating liquids from solids; Concentrating the liquid, juice and/or extract: heating and extracting the water to reach a range of about 70 or about 80 to about 90° Bx. Heating the concentrate to reach the melting point as defined above. Preparing a sugar solution, comprising simple and/or complex sugars, e.g., IMO, FOS etc., Combining the concentrated carrot, pear or apple extract and the sugar solution; Combining the concentrated carrot, pear or apple extract and stabilizers to create a homogeneous mass; Heating mass to reach the activation heat of the stabilizers; Aerating, e.g., by introducing gases into the mass; Wiping the mass by mechanical means; if extruder is utilized, Passing the mass through a nozzle as defined above; Transferring the mass; Drying and powdering the mass as defined above; Cutting and/or otherwise shaping the mass; Cooling in either a continuous of batch-wise operation; and then, Packaging.

Reference is made to FIG. 1, schematically presenting system 100 for the preparation of an aerated confectionary according to one embodiment of the invention. The system comprises, inter alia, a plurality of units constructed from materials suitable for the handling and treatment of food, such as stainless steel etc. In some embodiments of the invention, the units comprise one or more sensors configured to online analysis of the contents and process parameters, such as temperature, sugar content, viscosity, and pressure. In this schematic figure, the production system comprises inter alia an extraction unit 11 feeding to a pre-heating and concentration unit 13, through a filtration unit 12. In some embodiments of the current invention, concentration unit 13 comprises one or more sensors providing Brix reading of the mixture. The concentration unit 13 feeds to a reaction unit 14, configured to the preparation of the hereto defined confectionary. Reactor 14 is optionally further configured to receive mixtures from addition feeding and/or mixing units 13a. One or more additional units 13a are configured to prepare supplemental mixtures, such as sugar solutions and stabilizer solutions. In some embodiments of the invention, the aforesaid reaction unit is configured to prepare a confectionary mass and to aerate said mass by wiping. In some other embodiments, said reaction unit is configured to aerate the mixture by whipping. In some other embodiments, the mixture is aerated by being passed through a plurality of nozzles into a receiving and cooling unit 15. The mass is powdered 16 before being shaped, using a cutting or molding unit 16. The product is then packaged 17 for storage and shipping.

Reference is made to FIG. 2 schematically presenting a system for the production of gelatin-based marshmallows 200, having a premixing unit 1, a cooking unit 2, connected by plumbing 3 to all buffered units 4. The hereto cooked mass is now massed to an aerating unit 5, with the completed unit passed to an extruder 6 to produce a final product.

Reference is made to FIG. 3 schematically presenting a system for the production of deposited marshmallows 300. The system comprises, inter alia, a premixing unit 1, a cooking unit 2 with a buffering unit 3, feeding 4 to a heat exchanging unit. The cooked mass is transferred to an aerating unit 6, with the completed unit passed to an extruder 6 to produce therein a final product.

Reference is made to FIG. 4 schematically presenting a system for the production of deposited marshmallows 400, having a premixing unit 1, pumping 2 to a cooking unit 3 with a buffering unit 4 feeding to an aerating unit 5, with the completed unit passed to a depositing unit 6 to produce a final product.

### Fifth Process

TABLE 2
Marshmallow ingredients according to an embodiment of
the invention processable by the fifth process scheme.

| Clear apple concentrate | 86.79% (wt) | 200 | g |
|---|---|---|---|
| Cocoa butter | 0.01% (wt) | 0.03 | g |
| Gelatin | 4.77% (wt) | 11 | g |
| 1^{st} color agent | 1.13% (wt) | 2.6 | g |
| 2^{nd} color agent | 0.00% (wt) | 0 | |
| Carrot juice | 6.94% (wt) | 16 | g |
| 1^{st} flavor agent | 0.35% (wt) | 0.8 | g |
| 2^{nd} flavor agent | 0.00% (wt) | 0 | g |

| | | |
|---|---|---|
| total | 100.00% (w) | 230.43 |

In this embodiment of the invention, a carrot-free marshmallow is produced. Ingredients are as follows (weight percentage): clear apple concentrate 86.70 to 90%; cocoa butter/palm kernel fat 0.01 to 0.3%; crystalline fish gelatin 4.77 to 6% l natural colorant 1.113 to 2%; Carrot juice 6.94to 9%; and natural flavour agent 0.8 to 2%. The process comprises steps of cooking apple concentrate in an open pot (at ambient pressure), 500 liters, with a double wall heated by steam at a pressure of 6 atm.

Second step is cooking the same at 106° C., then adding fat to prevent whipping and sliding the concentrate over the sides of the cooking tank. At this temperature begins the tumult of the whipped cream that interferes with the cooking process. Cooking is continued to a temperature of 116 to 121° C. until a concentration of 85 to 88° Bx is yielded. In a following step, transferring the hereto cooked concentrate to an intermediate container with a stirrer and cool to a temperature of 80° C.

A following step is admixing gelatin solution, color agents and extract, and transferring to a work container. Following that, a step of whipping that same in a continuous frother (e.g., a Mondomixer) while introducing air and reaching a specific gravity of about 200 g per liter. Then transferring the same to an extruder and pouring the marshmallow. Oil or fact can be admixed to reduce the amount of bubbles during the boiling process. Much similarly, antifoam agents such as silicone materials can be added.

It is acknowledged in this respect that at least a portion of the apple concentrate is replaceable with other vegetative extracts, such as a carrot extract and a food mixer is replaceable with scraper-based food mixers.

The cooking process can be done also at lower temperature (for instance 112° C., and additional cooking with vacuum to remove rest of water (moisture) from the recipe until achieving 85 to 88° Bx.

The mixture of Gelatin mix (gelatin and carrots juice) can be done also in continuous process (tot batch wise) same also for color and flavor adding.

### Sixth Process

Chromatography is a general name for a variety of separation techniques based on the interaction between various compounds (in a mixture) with the stationary phase vs. the mobile phase (such as a liquid, usually water-or solvent-based). The relative strength of compound(s) interaction(s) with the two phases dictates the relative rate of movement. The interactions can be based on various physical parameters of the compounds, such as size, polarity, ionic charge etc.

### Column Chromatography

In some embodiments of chromatography, the stationary phase is compressed into a column. Commonly used materials include alumina, manganese, silica gel, starch and saccharides (sugar-based compound). In order to achieve the best possible separation, it is best to use uniform particles (shape and size).

The interaction between the compound(s) and the stationary phase can be based on various characteristics of the molecule, such as polarity, ionic charge, size etc.

An example for this process comprises the steps of:
Placing an amount of stationary phase in the column;
Adding the mixture to the top of the column (this can be conducted by using a small sample of the mobile phase, such as <25 ml).
Adding additional mobile phase, as all of the wanted material passes through the stationary phase and exits the column.
Collecting the fractions as they exit the column. The various compounds can be identifies using analytical methods (such as spectroscopic analysis).

### Ion Exchange Chromatography (Ion-Exchange Resin or Ion-Exchange Polymer)

Ion-exchange chromatography (or Ion chromatography) (IEC) relates to the use of a ionic stationary phase and enables the separation of polar and/or charged molecules and ions. The separation is based on their affinity to a stationary phase, a ion exchanger (also known as an ion-exchange resin or an ion-exchange polymer). The molecule-stationary phase affinity is mainly based on electrostatic interactions between the charged groups on the molecules and the stationary phase. Ion-exchange chromatography can be used for most category of charged molecule, such as proteins, nucleotides, and amino acids.

The IEC stationary phase consists of an immobile matrix, often crosslinked polystyrene, that contains charged ionizable functional groups or ligands. The stationary phase surface displays ionic functional groups (R-X) that interact with analyte ions of opposite charge on the molecules.
weakly acidic matrix's typically feature carboxylic acid groups,
weakly basic matrix's typically feature primary, secondary, and/or tertiary amino groups, e.g. polyethylene amine.

Ion-exchange chromatography retains the analyte on the column based on coulombic (ionic) interactions. The IEC matrix

General method for the separation/purification/deionization of fruit/vegetable juice:
Filtration (10 micron);
Filtration/Purification by a passing through a strong cationic polymer;
Renewal with an acid (HCl);
Filtration/purification by passing through a week anionic polymer;
Renewal with a base solution (NaOH);
Purification with a with activated carbon;
Concentration (to Brix70);

### EXAMPLES

### Ex. 1

Defined below are a plurality receipts of an areared confiture according to a few embodiments of the invention, wherein in a first example being an embodiment of the technology, a carrot, Beta vulgaris i.e., beet, apple and/or pumpkin based, vegetarian marshmallow comprises: carrot extract: 70%; gelatin: 4.5%; carrot, water or juice (pear and/or apple): 12%; inulin and/or oligofructose: 13.5%. In this embodiment, the gelatin is mixed with the carrot, pear and/or apple juice before being added to the extract.

### Ex. 2

A second example being an embodiment of the technology defines a carrot, grapes, pears and/or berries-based vegan marshmallow comprises: carrot and/or other fruits extract: 70%; protein 1.5%. This protein can be characterized as concentrated, isolate or hydrolyzed. Starch: 1.5%; carrot, water and/or juice (pear and/or apple): 12% and oligofructose and/or inulin: 13.5%. In this embodiment, the protein and starch are mixed with the carrot, pear and/or apple juice before being added to the extract.

### Ex. 3

A third example being an embodiment of the technology defines a carrot, pear and/or apple, strawberry and/or tomato-based vegan marshmallow comprises: carrot and/or other fruits extract: 70%; protein and starch mixture: 16%; carrot, pear and/or apple and/or other fruits juice: 12%. In this embodiment, the protein and starch mixture are mixed with the carrot, pear and/or apple and/or other fruits juice before being added to the extract.

### Ex. 4

A fourth example being an embodiment of the technology defines carrot, pear and/or apple, pumpkin and/or turnip-based vegan marshmallow comprises: carrot, pear and/or apple and/or other fruits extract: 40%; sugar (sucrose): 30%; protein 1.5%. The protein can be characterized as isolate or hydrolyzed. Stabilizers and/or starch: 1.5%; carrot, pear and/or apple and/or other fruits juice: 12%; In this embodiment, the protein and starch are mixed with the carrot, pear and/or apple and/or other fruits juice before being added to the extract.

### Ex. 5

A fifth example being an embodiment of the technology defines carrot, pear and/or apple and/or citrus based vegan marshmallow comprises: fruit sugar: 40%; oligofructose: 25%; sugar (sucrose): 30%; protein 1.5%. The protein can be characterized as concentrated, isolate or hydrolyzed. stabilizers: 1.5% and carrot, water and/or juice (carrot, pear apple and/or citrus): 12%. In this embodiment, the protein and starch are mixed with the carrot/citrus juice before being added to the extract.

### Ex. 6

A sixth example being an embodiment of the technology defines carrot, pear and/or apple and/or beet-based vegan marshmallow comprises: syrup of high sugar content 30%; fruit sugar: 35%; oligofructose: 25%; protein and starch mixture: 16% and fruit juice or water: 5%. In this embodiment. the protein and starch mixture are mixed and hydrated with the fruit/water juice by a steam system.

### Ex. 7

A method of preparing a marshmallow. using different compositions containing various sugar sources and fractions:

| | Composition | | | Product characteristics |
|---|---|---|---|---|
| Ex. | Sugar(s) | Other | Moisture | (Density, etc.) |
| 7.1 | Carrot juice | Gelatin (4.73%), | 25% (At start) | Product didn't stabilize |
| | (11.83%), Carrot | Inulin (14.79%) | | (Density ~1) |
| | concentrate | | | |
| | (68.64%) | | | |
| 7.2 | Carrot | Pectin (2.84%), Ca | 18% (At start) | Product didn't stabilize |
| | concentrate Brix | Lactate (1.27%), | | (Density ~1) |
| | 80 (89.45%) | Xanthian (0.25%), | | |
| | | Protein (6.1%) | | |
| 7.3 | Glucose | Carrageenan | 26% (At start) | Product not stable and |
| | (43.21%), Sugar | (1.94%) Pectin | | collapsed |
| | (35.76%), Carrot | (2.84%), Ca | | (Density ~1) |
| | juice (14.96%), | Lactate (1.27%), | | |
| | | Xanthian (2.5%), | | |
| | | Protein (6.1%) | | |
| 7.4 | Glucose | Protein (1.38%), | 26% (At start) | Product did not |
| | (28.47%), Sugar | Carrageenan | | emulsify or stabilize |
| | (36.49%), Carrot | (1.93%) | | (Density ~1) |
| | Concentrate Brix | | | |
| | 80 (15.13%), | | | |
| 7.5 | Apple | Gelatin (4.8%) | 11% (Added | Stabilized - |
| | Concentrate | | Water - At start) | Emulsification not good |
| | (85.8%), | | | or uniform |
| | | | | (Density ~1) |
| 7.6 | Deionized | Gelatin (3.96%), | | Stabilized (Density |
| | Apple | Vanilla extract | | 0.24) |
| | concentrate | (0.22%) | | pH 4.5 |
| | (88.52%), | | | |
| | Carrot Juice | | | |
| | Brix 65 (7.31%) | | | |
| 7.7 | Deionized | Gelatin (3.64%), | | Stabilized (Density |
| | Apple | Vanilla extract | | 0.26) |
| | concentrate | (0.20%) | | pH 4.5, |
| | (81.45%), | | | Brix 83.5 |
| | Carrot Juice | | | Good taste profile |
| | Brix 65 | | | |
| | (6.73%), | | | |
| | Deionized | | | |
| | Carrot | | | |
| | concentrate | | | |
| | (7.98%), | | | |

The deionized apple concentrate has a pH of 3.7-4.0, soluble solids of 65-72° BRIX, acidity of 0.4-0.7% and a formol number of 104 ± 10%.

The experiments show that a composition containing mainly fruit juice cannot be used to create a stabile seriated confectionary. By exchanging at least 70% of the fruit juice with deionized fruit juice creates a stabile aeriated confectionary, with a density similar to that of marshmallow made from sugar and having a favorable taste profile.

### Ex. 8

A method of preparing a soft sugar candy, using different compositions
containing various sugar sources and fractions:

| | Composition | | | Product characteristics |
|---|---|---|---|---|
| Ex. | Sugar(s) | Other | Moisture | (Density, etc.) |
| 8.1 | Deionized | Pectin D100 (2%), | 46.5% (at start) | Stabilized |
| | Apple | Lemon juice (1%) | | pH 4.0-4.5 at start |
| | concentrate | | | pH 3.5 following cooking |
| | (67%), Carrot | | | |
| | Juice (26%), | | | |
| | Sugar (4%) | | | |
| 8.2 | Deionized | Pectin D100 (2%), | 41.5% (at start) | Stabilized |
| | Carrot | Lemon juice (1%), | | pH 4.0-4.5 at start |
| | concentrate | Dietary Fiber | | pH 3.5 following cooking |
| | (50%), Carrot | (17%) | | |
| | Juice (26%), | | | |
| | Sugar (4%) | | | |
| 8.3 | Deionized | Pectin D100 (2%), | 46.5% (at start) | Stabilized |
| | Apple | Lemon juice (1%) | | pH 4.0-4.5 at start |
| | concentrate | | | pH 3.5 following cooking |
| | (33%), | | | |
| | Deionized | | | |
| | Carrot | | | |
| | concentrate | | | |
| | (33%), Carrot | | | |
| | Juice (26%), | | | |
| | Sugar (4%) | | | |
| 8.4 | Carrot | Pectin D100 (2%), | 44% (At start) | Product did not stabilize |
| | concentrate Brix | Citric Acid (1%) | | (Bitter taste) |
| | 70(44%), Carrot | | | |
| | juice (19%), | | | |

The experiments show that a composition containing mainly fruit juice cannot be used to create a stabile aeriated confectionary. By exchanging at least 50% of the fruit juice with deionized fruit juice creates a stabile confectionary, with a density similar to that of sugar candy made from sugar and having a favorable taste profile.

1-37. (canceled)

38. A method for the production of low-calorie confectionary comprising steps of:
a) obtaining a clear plant-based product of about 80 to about 90%; fat, about 0.0075 to about 0.5%; a stabilizer, about 4 to about 7.5;
b) cooking said plant-based product in an open pot at about 97 to about 110° C.;
c) adding and mixing fat at temperature of about 110 to about 125° C. until a concentration of about 80 to about 90° Bx is yielded;
d) transferring the hereto cooked concentrate to an intermediate container with a stirrer and cool to a temperature of about 80° C.;
e) admixing solution of said stabilizer, optionally color agents and flavor extract; and
f) transferring obtained mass to an extruder and pouring the confectionary;
wherein said plant-based product is characterized as one or more of the following: a juice, a concentrate, and a plant extract, obtained from homogenous or heterogenous raw-material of a plant selected from the group consisting of tubers, vegetables, berries, fruit and a mixture thereof;
further wherein said plant-based product is characterized by being at least 70% deionized or demineralized.

39. The method of claim 38, wherein said stabilizer is selected from the group consisting of emulsifiers, thickeners and gelling agents, foam stabilizers, humectants, anticaking agents, and coating agents, alginate, agar, carrageenan, cellulose, CMC and cellulose derivatives, gelatin, guar gum, gum Arabic, locust bean gum, pectin, starch, xanthan gum, proteins, albumen, gellan gum, LBG and a mixture thereof.

40. The method of claim 38, said method additionally comprising steps of aerating said hereto cooked concentrate by means of whipping the same in a continuous frother while introducing air and reaching a specific gravity of about 180 to about 220 g per liter, wherein said confectionary is an aerated confectionary characterized by density of about 0.25 to about 0.8 g/ml.

41. The method of claim 38, additionally comprising a step of admixing one or more of the following: oil, fat, fibers, antifoam agents including silicone materials to reduce the amount of bubbles during the boiling process.

42. The method of claim 38, additionally comprising a step of transferring to a work container.

43. The method of claim 38, additionally comprising steps of separating a liquid fraction of said plant extract from a solid fraction of said plant extract, wherein said steps of separating said liquid fraction from said solid fraction are conducted by a technology selected from the group consisting of extracting, distilling, filtrating, applying sedimentation and decanting.

44. The method of claim 43, additionally comprising steps of enriching saccharide content of said liquid fraction of said plant extract.

45. The method of claim 44, wherein said saccharide is selected from a group consisting of glucose, sucrose, fructose, dextrin, maltose, and dextrose.

46. The method of claim 38, additionally comprising a step of adding one or more colorants up to about 1% to about 2.5%.

47. The method of claim 38, additionally comprising a step of adding one or more flavor agent about up to 0.7 to about 2.5%.

48. The method of claim 38, wherein said step of obtaining said plant-based product, further comprising a step of purifying a fruit or vegetable, said step selected from a group consisting of filtration, ion-exchange chromatography and active carbon.

49. The method of claim 48, wherein said ion-exchange chromatography is characterized as being an anionic polymer or a cationic polymer.

50. A low-calorie confectionary, the starting products for said confectionary comprising:
a clean plant-based product; fat; a stabilizer, and optionally color agents and flavor extract; wherein said plant-based product is characterized as one or more of the following: a juice, a concentrate, and a plant extract, obtained from homogenous or heterogenous raw-material of a plant selected from the group consisting of tubers, vegetables, berries, fruit and a mixture thereof;
further wherein said plant-based product is characterized by being at least 70% deionized or demineralized.

51. The confectionary of claim 50, wherein at least one of the following is being held true:
a) said plant-based product has a Bix measurement of about 50 to about 90° Bx; and
b) said plant-based product has a Bix measurement of about 70 to about 90° Bx.

52. The confectionary of claim 50, wherein at least one of the following is being held true:
a) said plant-based product comprises at least about 40% of said confectionary;
b) said plant-based product comprises at least about 70% of said confectionary; and
c) said plant-based product comprises about 80 to about 90% of said confectionary.

53. The confectionary of claim 50, additionally comprising saccharide, said saccharide constituting about 1 to about 30% of said confectionary, wherein at least one of the following is being held true:
a) said saccharide is selected from a group consisting of monosaccharides, disaccharides, polysaccharides and a mixture thereof;
b) said saccharide is selected from a group consisting of glucose, sucrose, fructose, dextrin, maltose, dextrose and a mixture thereof; and
c) said saccharide content comprises less than about 20% invert sugar.

54. The confectionary of claim 50, wherein said stabilizer is selected from the group consisting of emulsifiers, thickeners and gelling agents, foam stabilizers, humectants, anticaking agents, and coating agents, alginate, agar, carrageenan, cellulose, CMC and cellulose derivatives, gelatin, guar gum, gum Arabic, locust bean gum, pectin, starch, xanthan gum, proteins, albumen, gellan gum, LBG and a mixture thereof.

55. The confectionary of claim 50, wherein said confectionary additionally comprising fibers, said fibers are selected from the group consisting of polysaccharides, oligosaccharides, fructo-oligosaccharides, oligofructose, oligo-fructofuranans, inulin, isomalto-oligosaccharide, isomalto-oligosaccharide and any combination thereof.

56. The confectionary of claim 50, wherein said fibers comprising about 1 to about 15% of said confectionary.

57. The confectionary of claim 50, wherein at least one of the following is being held true:
a) said confectionary having a density of about 0.25 to about 0.8 g/ml;
b) said confectionary being crystal free;
c) said plant is selected from a group consisting of carrot, pear and apple;
d) having a moisture content comprising about 12 to about 25% W/W of the composition;
e) said confectionary comprising one or more colorants up to about 1% to about 2.5%;
f) said confectionary comprising one or more flavor agent about up to 0.7 to about 2.5%;
g) said confectionary comprising only natural ingredients;
h) said confectionary being vegan; and
i) said confectionary being vegetarian.
